(19) United States
(12) Patent Application Publication
(10) Pub. No.: US 2012/0219781 A1
(43) Pub. Date: Aug. 30, 2012

(54) Compositions based on copolyether-block-amides, on copolyether-block-esters, on functionalized polyolefins and on starch for waterproof-breathable film applications

(75) Inventors: Perrine Babin, Rouen (FR); Guillaume Le, Colombelles (FR); Benoit Brule, Beaumont-Le-Roger (FR)

(73) Assignee: Arkema France, Colombes (FR)

(21) Appl. No.: 13/334,708

(22) Filed: Dec. 22, 2011

(30) Foreign Application Priority Data
Dec. 27, 2010 (FR) 10.61269

(51) Int. Cl. C08L 3/02; B29C 49/04; B29C 47/78

(52) U.S. Cl. 428/220; 524/47; 524/52; 264/164; 264/555

(57) ABSTRACT

A waterproof-breathable film comprising:

a) a copolyether-block-amide and/or a copolyether-block-ester and/or a functionalized polyolefin;
b) starch.

This film can be used as roof-decking film or wall insulating film for a dwelling.

### TECHNICAL FIELD

The technical field to which the invention relates is that of waterproof-breathable films used as insulating materials under the roofing of dwellings and for the insulation of walls.

### STATE OF THE ART

A roof-decking film is a flexible film positioned between the roof structure and the covering material of a dwelling. Its role is, on the one hand, to prevent external elements, such as dust, pollen, sand, rain and snow, from infiltrating under the roofing and, on the other hand, to prevent the moisture produced by human activity from accumulating in the dwelling. This film makes possible the discharge of the water vapour from the frame. Such a film can be waterproof-breathable, that is to say be simultaneously permeable to water vapour and impermeable to water. The use of a waterproof-breathable roof-decking film makes it possible to have a dwelling which breathes and which is thus healthy for its occupants.

The following documents describe various compositions for waterproof-breathable films which can be used under the roofing of a building.

The document FR-A-2 639 644 describes a thermoplastic elastomer film permeable to water vapour based on polyetheresteramide and preferably on copolyether-block-amide, such as those of the PEBAX® family which are sold by Arkema. These polymers are characterized by a very high permeability to water vapour.

The document EP-A-0 688 826 describes a mixture comprising:
a) at least one thermoplastic elastomer having polyether blocks, such as a copolyether-block-amide;
b) at least one copolymer comprising ethylene and at least one alkyl (meth)acrylate.

The document WO 02/12376 describes a mixture:
a) of at least one polymer (a) taken from the group consisting of an ethylene/alkyl (meth)acrylate copolymer (a1), an optionally neutralized ethylene/(meth)acrylic acid copolymer (a2), an ethylene/vinyl monomer copolymer (a3), the mixture (a1) and (a2), the mixture (a1) and (a3), the mixture (a2) and (a3) and the mixture (a1), (a2) and (a3); and/or
b) of at least one functionalized polyethylene (b); and
c) of at least one copolymer (c) having copolyamide blocks or polyester blocks and polyether blocks.

Some films manufactured from copolyether-block-esters, such as those of the Hytrel® range sold by DuPont de Nemours, also exhibit waterproof-breathable properties and can thus be used as roof-decking films.

Regulations regarding the construction of dwellings require the insulating materials used under the roofing and on the external walls of a dwelling to exhibit a minimum permeability to water vapour. The permeability to water vapour is evaluated using the parameter MVTR (moisture vapour transmission rate). In particular, it is desirable for a waterproof-breathable film used as wall insulating film (house wrapping) to exhibit an MVTR value, measured by method A, of at least 70 g/m² for 24 hours at 23° C. for a relative humidity of 50% and a film thickness of 25 μm. It is also desirable for the minimum permeability to be at least 350 g/m² under the same measurement conditions when the film is used under the roofing.

This stricter requirement for the roof-decking film is explained by the fact that hot air rises towards the roof by convection and that the temperature there is thus higher, resulting in a greater amount of water vapour at the top to be discharged.

Known roof-decking films are manufactured from synthetic polymers. In point of fact, synthetic polymers are manufactured from non-renewable starting materials. Attempts are being made to limit their amount in the manufacture of a waterproof-breathable film. The aim is thus to find a film which is obtained at least partially from natural (or bioresourced) starting materials and which exhibits a permeability at least as good as that of a film obtained from synthetic polymers. In particular, the aim is to find a film which is obtained at least partially from natural starting materials and which satisfies the permeability requirements indicated above. The aim is also to find a waterproof-breathable film which exhibits a high permeability to water vapour and a good lifetime, in order to guarantee the continuity of the whole of the roofing. In other words, the aim is to find a waterproof-breathable film which is not easily decomposed by prolonged exposure to moisture.

Finally, the films of the prior art described above are obtained by shaping the mixture comprising the various polymers. The shaping can be carried out according to any known extrusion process, such as flat die extrusion calendering, extrusion-acrylic resin coating or blow extrusion. Generally, the extrusion temperature is at least 200° C., which requires a high heating power. The aim is thus to find a waterproof-breathable film which can be manufactured at a heating or extrusion temperature lower than 200° C., preferably lower than 190° C., preferably lower than 180° C.

### SUMMARY OF THE INVENTION

To this end, the invention provides a waterproof-breathable film comprising:

a) a copolyether-block-amide and/or a copolyether-block-ester and/or a functionalized polyolefin;
b) starch.

According to one embodiment, the percentage of starch represents from 10 to 90% of the weight of the composition, preferably from 30 to 80% and more preferably from 40 to 70% of the weight of the composition.

According to one embodiment, the copolyether-block-amide comprises from 1 to 80% by weight of polyether blocks and from 20 to 99% by weight of polyamide blocks, preferably from 4 to 80% by weight of polyether blocks and from 20 to 96% by weight of polyamide blocks and more preferably from 30 to 60% by weight of polyether blocks and from 40 to 70% by weight of polyamide blocks.

According to one embodiment, the polyamide block is chosen from the group consisting of the 6, 11, 12, 6.6, 6.10 or 6.12 blocks.

According to one embodiment, the polyether block derives from polyethylene glycol (PEG).

According to one embodiment, the copolyether-block-amide comprises at least one PA12 block and at least one PEG block.

According to one embodiment, the functionalized polyolefin comprises a grafting by a monomer chosen from the group consisting of unsaturated carboxylic acids, unsaturated carboxylic acid anhydrides, vinyl monomers, acrylic monomers and a mixture of these.

According to one embodiment, the functionalized polyolefin is a copolymer of ethylene and methyl acrylate.

According to one embodiment, the functionalized polyolefin is chosen from the group consisting of ethylene/acrylic ester copolymers, ethylene/acrylic ester/maleic anhydride copolymers and ethylene/acrylic ester/glycidyl methacrylate copolymers.

According to one embodiment, the film has a thickness of between 25 and 500 μm, preferably between 50 and 400 μm.

This film can be used as insulator under the roofing of a building or to insulate the walls of the building. Such a film exhibits both good durability and better permeability to water vapour. The film retains over time its property of barrier to the external elements which might infiltrate into the dwelling. The improvement in the permeability of the film to water vapour favours the ventilation in the dwelling.

Another subject-matter of the invention is a process for the manufacture of the film according to the invention, comprising the stages of:

a) making available a polymer chosen from a copolyether-block-amide, a copolyether-block-ester and a functionalized polyolefin;
b) making available starch;
c) mixing and heating the polymer or polymers of stage a) and the starch at a temperature greater than the melting point of the polymer or polymers of stage a) and than the melting point of the starch;
d) drawing the mixture in order to form a film.

According to one embodiment, the stage of drawing the mixture is carried out by blow extrusion.

According to one embodiment, the stage of drawing the mixture is carried out by cast extrusion.

According to one embodiment, the heating of stage c) is carried out at a temperature lower than 200° C., preferably lower than 190° C. and more preferably lower than 180° C.

### BRIEF DESCRIPTION OF THE FIGURE

FIG. 1 represents the value of the permeability measured on films of different compositions. Examples A-D are comparative. Examples E and F are according to the invention.

### DETAILED ACCOUNT OF THE EMBODIMENTS OF THE INVENTION

The invention is now described in more detail and without implied limitation in the description which follows.

The polymers used in the film according to the invention can be chosen from copolyether-block-amides, copolyether-block-esters and functionalized polyolefins or a mixture of these.

The copolyether-block-amides, abbreviated to “PEBA”, also known as copolymers comprising polyether blocks and polyamide blocks, result from the polycondensation of polyamide blocks comprising reactive ends with polyether blocks comprising reactive ends, such as, inter alia:

1) polyamide blocks comprising diamine chain ends with polyoxyalkylene blocks comprising dicarboxyl chain ends;

2) polyamide blocks comprising dicarboxyl chain ends with polyoxyalkylene blocks comprising diamine chain ends, which are obtained by cyanoethylation and hydrogenation of aliphatic α,ω-dihydroxylated polyoxyalkylene blocks, known as polyetherdiols;

3) polyamide blocks comprising dicarboxyl chain ends with polyetherdiols, the products obtained being, in this specific case, polyetheresteramides.

The polyamide blocks comprising dicarboxyl chain ends originate, for example, from the condensation of precursors of polyamides in the presence of a chain-limiting dicarboxylic acid. The polyamide blocks comprising diamine chain ends originate, for example, from the condensation of precursors of polyamides in the presence of a chain-limiting diamine.

The number-average molar mass Mn of the polyamide blocks is between 400 and 20 000 g/mol, preferably between 500 and 10 000 g/mol.

The polymers comprising polyamide blocks and polyether blocks can also comprise randomly distributed units.

Use may be advantageously made of three types of polyamide blocks.

According to a first type, the polyamide blocks originate from the condensation of a dicarboxylic acid, in particular those having from 4 to 20 carbon atoms, preferably those having from 6 to 18 carbon atoms, and of an aliphatic or aromatic diamine, in particular those having from 2 to 20 carbon atoms, preferably those having from 6 to 14 carbon atoms.

Mention may be made, as examples of dicarboxylic acids, of 1,4-cyclohexanedicarboxylic acid, butanedioc, adipic, azelaic, suberic, sebacic, dodecane-dicarboxylic and octadecanedicarboxylic acids and terephthalic and isophthalic acids, but also dimerized fatty acids.

Mention may be made, as examples of diamines, of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and para-amino-dicyclohexylmethane (PACM), and isophoronediamine (IPDA), 2,6-bis(aminomethyl)norbornane (BAMN) and piperazine (Pip).

The following blocks advantageously exist: PA4.12, PA4.14, PA4.18, PA6.10, PA6.12, PA6.14, PA6.18, PA9.12, PA10.10, PA10.12, PA10.14 and PA10.18, the first figure indicating the number of carbon atoms of the diamine and the second figure indicating the number of carbon atoms of the dicarboxylic acid.

According to a second type, the polyamide blocks result from the condensation of one or more α,ω-aminocarboxylic acids and/or of one or more lactams having from 6 to 12 carbon atoms in the presence of a dicarboxylic acid having from 4 to 12 carbon atoms or of a diamine. Mention may be made, as examples of lactams, of caprolactam, oenantholactam and lauryllactam. Mention may be made, as examples of α,ω-aminocarboxylic acid, of aminocaproic, 7-aminoheptanoic, 11-aminoundecanoic and 12-aminododecanoic acids.

Advantageously, the polyamide blocks of the second type are of polyamide 11, of polyamide 12 or of polyamide 6.

According to a third type, the polyamide blocks result from the condensation of at least one α,ω-aminocarboxylic acid (or one lactam), at least one diamine and at least one dicarboxylic acid.

In this case, the polyamide PA blocks are prepared by polycondensation:
of the linear aliphatic or aromatic diamine or diamines having X carbon atoms;
of the dicarboxylic acid or acids having Y carbon atoms; and
of the comonomer or comonomers {Z} chosen from the lactams and the α,ω-aminocarboxylic acids having Z carbon atoms and the equimolar mixtures of at least one diamine having X1 carbon atoms and of at least one dicarboxylic acid having Y1 carbon atoms, (X1, Y1) being different from (X, Y),
the said comonomer or comonomers {Z} being introduced in a proportion by weight ranging up to 50%, preferably up to 20% and more advantageously still up to 10%, with respect to the combined polyamide precursor monomers;
in the presence of a chain-limiting agent chosen from dicarboxylic acids.

Use is advantageously made, as chain-limiting agent, of the dicarboxylic acid having Y carbon atoms, which is introduced in excess with respect to the stoichiometry of the diamine or diamines.

According to an alternative form of this third type, the polyamide blocks result from the condensation of at least two α,ω-aminocarboxylic acids or of at least two lactams having from 6 to 12 carbon atoms or of a lactam and of an aminocarboxylic acid not having the same number of carbon atoms, in the optional presence of a chain-limiting agent. Mention may be made, as examples of aliphatic α,ω-aminocarboxylic acid, of aminocaproic, 7-aminoheptanoic, 11-aminoundecanoic and 12-aminododecanoic acids. Mention may be made, as examples of a lactam, of caprolactam, oenantholactam and lauryllactam. Mention may be made, as examples of aliphatic diamines, of hexamethylenediamine, dodecamethylenediamine and trimethylhexamethylenediamine. Mention may be made, as an example of cycloaliphatic diacids, of 1,4-cyclohexanedicarboxylic acid. Mention may be made, as examples of aliphatic diacids, of butanedioic, adipic, azelaic, suberic, sebacic and dodecanedicarboxylic acids, dimerized fatty acids (these dimerized fatty acids preferably have a dimer content of at least 98%; preferably, they are hydrogenated; they are sold under the Pripol® trade name by Uniqema or under the Empol® trade name by Henkel) and polyoxyalkylene-α,ω-diacids. Mention may be made, as examples of aromatic diacids, of terephthalic (T) and isophthalic (I) acids. Mention may be made, as examples of cycloaliphatic diamines, of the isomers of bis(4-aminocyclohexyl)methane (BACM), bis(3-methyl-4-aminocyclohexyl)methane (BMACM), and 2,2-bis(3-methyl-4-aminocyclohexyl)propane (BMACP), and para-amino-dicyclohexylmethane (PACM). The other diamines commonly used can be isophoronediamine (IPDA), 2,6-bis(aminomethyl)norbornane (BAMN) and piperazine.

Mention may be made, as examples of polyamide blocks of the third type, of the following:
6.6/6 in which 6.6 denotes hexamethylenediamine units condensed with adipic acid and 6 denotes units resulting from the condensation of caprolactam.
6.6/6.10/11/12 in which 6.6 denotes hexamethylenediamine condensed with adipic acid, 6.10 denotes hexamethylenediamine condensed with sebacic acid, 11 denotes units resulting from the condensation of aminoundecanoic acid and 12 denotes units resulting from the condensation of lauryllactam.

Preferably, the polymer comprises from 1 to 80% by weight of polyether blocks and from 20 to 99% by weight of polyamide blocks, preferably from 4 to 80% by weight of polyether blocks and from 20 to 96% by weight of polyamide blocks and more preferably from 30 to 60% by weight of polyether blocks and from 40 to 70% by weight of polyamide blocks. The mass Mn of the polyether blocks is between 100 and 6000 g/mol and preferably between 200 and 3000 g/mol.

The polyether blocks consist of alkylene oxide units. These units can, for example, be ethylene oxide units, propylene oxide units or tetrahydrofuran units (which results in the polytetramethylene glycol sequences). Use is thus made of PEG (polyethylene glycol) blocks, that is to say those consisting of ethylene oxide units, PPG (polypropylene glycol) blocks, that is to say those consisting of propylene oxide units, PO3G (polytrimethylene glycol) blocks, that is to say those consisting of polytrimethylene ether glycol units (such copolymers with polytrimethylene ether blocks are described in the document U.S. Pat. No. 6,590,065), and PTMG blocks, that is to say those consisting of tetramethylene glycol units, also known as polytetrahydrofuran blocks. The PEBA copolymers can comprise several types of polyethers in their chain, it being possible for the copolyethers to be block or random copolyethers. The permeability to water vapour of the PEBA copolymer increases with the amount of polyether blocks and varies as a function of the nature of these blocks. It is preferable to use a polyethylene glycol polyether block which makes it possible to obtain a PEBA exhibiting good permeability.

The polyether blocks can also consist of ethoxylated primary amines. Mention may be made, as examples of ethoxylated primary amines, of the products of formula:

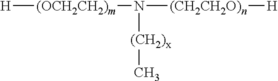

in which m and n are between 1 and 20 and x is between 8 and 18. These products are commercially available under the Noramox® trade name from CECA and under the Genamin® trade name from Clariant.

The soft polyether blocks can comprise polyoxyalkylene blocks comprising NH₂ chain ends, it being possible for such blocks to be obtained by cyanoacetylation of aliphatic α,ω-dihydroxylated polyoxyalkylene blocks, known as polyetherdiols. More particularly, use may be made of Jeffamines (for example, Jeffamine® D400, D2000, ED 2003 or XTJ 542, commercial products from Huntsman, also described in the documents of Patents JP 2004346274, JP 2004352794 and EP 1 482 011). The polyetherdiol blocks are either used as is and copolycondensed with polyamide blocks comprising carboxyl ends or they are aminated in order to be converted into polyetherdiamines and condensed with polyamide blocks comprising carboxyl ends. The general method for the two-stage preparation of PEBA copolymers having ester bonds between the PA blocks and the PE blocks is known and is described, for example, in French Patent FR 2 846 332. The general method for the preparation of the PEBA copolymers of the invention having amide bonds between the PA blocks and the PE blocks is known and described, for example, in European Patent EP 1 482 011. Polyether blocks may also be mixed with polyamide precursors and a chain-limiting diacid in order to prepare polymers comprising polyamide blocks and polyether blocks having randomly distributed units (one-stage process).

Of course, the designation PEBA in the present description of the invention relates equally well to the PEBAX® products sold by Arkema, to the Vestamid® products sold by Evonik®, to the Grilamid® products sold by EMS, to the Kellaflex® products sold by DSM or to any other PEBA from other suppliers.

Advantageously, the PEBA copolymers have PA blocks of PA6, of PA11, of PA12, of PA6.12, of PA6.6/6, of PA10.10 and/or of PA6.14, preferably PA11 and/or PA12 blocks; and PE blocks of PTMG, of PPG and/or of PO3G. The PEBAs based on PE blocks consisting predominantly of PEG are to be ranked in the range of the hydrophilic PEBAs. The PEBAs based on PE blocks consisting predominantly of PTMG are to be ranked in the range of the hydrophobic PEBAs.

Advantageously, the said PEBA used in the composition according to the invention is obtained, at least partially, from bioresourced starting materials. Starting materials of renewable origin or bioresourced starting materials is understood to mean substances which comprise bioresourced carbon or carbon of renewable origin. Specifically, unlike the substances resulting from fossil materials, the substances composed of renewable starting materials comprise ¹⁴C. The “content of carbon of renewable origin” or “content of bioresourced carbon” is determined by application of Standards ASTM D 6866 (ASTM D 6866-06) and ASTM D 7026 (ASTM D 7026-04). By way of example, the PEBAs based on polyamide 11 originate at least in part from bioresourced starting materials and exhibit a content of bioresourced carbon of at least 1%, which corresponds to a ¹²C/¹⁴C isotopic ratio of at least 1.2×10⁻¹⁴. Preferably, the PEBAs according to the invention comprise at least 50% by weight of bioresourced carbon with respect to the total weight of carbon, which corresponds to a ²C/¹⁴C isotopic ratio of at least 0.6×10⁻¹². This content is advantageously higher, in particular up to 100%, which corresponds to a ¹²C/¹⁴C isotopic ratio of 1.2×10⁻¹², in the case of PEBAs comprising PAH blocks and PE blocks comprising PO3G, PTMG and/or PPG resulting from starting materials of renewable origin.

Use may also be made of a copolyether-block-ester comprising a poly(oxyalkylene) block and a polyester block.

The polyester block can be obtained by polycondensation, by esterification, of a dicarboxylic acid, such as isophthalic acid or terephthalic acid or a biosourced dicarboxylic acid (such as furanedicarboxylic acid), with a glycol, such as ethylene glycol, trimethylene glycol, propylene glycol or tetramethylene glycol.

The polyether block can be as described above in connection with the PEBAs. The polymers of the Hytrel® range sold by DuPont de Nemours or those of the Arnitel® range sold by DSM are examples of copolyether-block-esters.

The functionalized polyolefin is a synthetic saturated aliphatic polymer resulting from the polymerization of an olefin, such as ethylene and its derivatives, to the main chain of which have been grafted monomers chosen, for example, from unsaturated carboxylic acids, unsaturated carboxylic acid anhydrides, vinyl monomers or acrylic monomers.

Mention may be made, as examples of unsaturated carboxylic acid, of (meth)acrylic acid, crotonic acid or cinnamic acid.

Mention may be made, as examples of unsaturated carboxylic acid anhydride, of citraconic anhydride, itaconic anhydride, tetrahydrophthalic anhydride, 2-methylmaleic anhydride, 2,3-dimethylmaleic anhydride and maleic anhydride.

Mention may be made, as examples of acrylic monomer, of acrylonitrile or acrylic esters, such as methyl (meth)acrylate, n-butyl (meth)acrylate, isobutyl (meth)acrylate, 2-ethylhexyl (meth)acrylate or glycidyl (meth)acrylate.

A polyolefin functionalized with methyl acrylate and glycidyl methacrylate is sold by Arkema under the name Lotader GMA®. A polyolefin functionalized with methyl acrylate, butyl acrylate and 2-ethylhexyl acrylate is sold by Arkema under the name Lotryl®. A polyolefin functionalized with methyl (meth)acrylate, ethyl (meth)acrylate, butyl (meth)acrylate and maleic anhydride is sold by Arkema under the name Lotader MAH®.

It has been discovered, on the one hand, that the combination of a copolyether-block-amide and/or of a copolyether-block-ester and/or of a functionalized polyolefin with starch makes it possible to improve the permeability of the film in comparison with a film comprising the polymers alone and, on the other hand, that, surprisingly, a film according to the invention exhibits good resistance to the decomposition brought about by moisture. This result is surprising as it is known that starch degrades and decomposes rapidly when it is exposed to moisture, as indicated in the documents U.S. Pat. No. 5,095,054, US 2008/0038496 and US 2007/0228046. In the last two documents, the starch is used in the manufacture of biodegradable bags intended for the temporary storage of organic waste. Without wishing to be committed to the theory, the Applicant Company considers that the polymers used in the invention protect the starch from decomposition due to moisture while making it possible for the starch to increase the permeability of the film to water vapour.

Any type of starch can be used in the invention. It can be maize, potato, wheat, tapioca or pea starch. The starch can be modified by grafting chemical groups. It can be employed in the following different forms:
native (unmodified) starch: the starch grains are the site of the semicrystalline organization of the two constituent polymers, which are amylose and amylopectin. The degree of polymerization and the proportion of amylose vary according to the botanical origin of the starch.
gelatinized starch: during heating in the vicinity of 80° C. in an aqueous medium, the starch hydrates and swells. A portion of the amylose and then of the amylopectin passes into solution (starching). The suspension then becomes viscous and the starch becomes easier to hydrolyse.
gelled starch—retrograded starch: when the temperature of the aqueous solution decreases, the system becomes gelled and then reorganized into a semicrystalline structure (retrogradation). These reorganized molecules are formed of amylose, of amylopectin and of mixed amylose/amylopectin crystals.
destructured starch, in which form the amylose and amylopectin polymers are dispersed.

In addition to the use of starch, which is a natural material, the use of PEBA polymers prepared from polyamide and/or polyether blocks at least partially bioresourced makes it possible to further increase the amount of natural materials in the film according to the invention.

It is possible, in order to manufacture the composition according to the invention, to prepare a mixture of the polymer or polymers with starch and to then melt the mixture by heating to a temperature greater than the melting point of the polymer or polymers and than the melting point of the starch. The mixture is then drawn to form a film. The heating of the polymer or polymers can be carried out separately from the stage of heating the starch, the molten polymer or polymers and the starch subsequently being mixed.

Advantageously, the mixture of the polymer or polymers with the starch is extruded in the presence of water. This makes it possible to lower the melting point of the mixture and thus to be able to convert the mixture at a lower temperature. A saving in energy is thus obtained and the risk of decomposition of the polymer or polymers and of the starch is limited. Preferably, the heating or extrusion temperature is lower than 200° C., preferably lower than 190° C. and more preferably lower than 180° C.

The film can, for example, be obtained by blow extrusion or cast extrusion. The extrusion temperature varies as a function of the polymer used and of the process for formation of the film. The film obtained is provided in the form of a dispersion of starch particles in a polymer matrix.

### EXAMPLES

Waterproof-breathable films were prepared from mixtures comprising various proportions of a copolyether-block-amide PEBA, of a functionalized polyolefin and of thermoplastic starch.

The copolyether-block-amide used in the examples below belongs to the range of the hydrophilic PEBAs sold by Arkema and in particular those for which the polyether block is derived from polyethylene glycol. It is in this instance Pebax® MV3000.

The functionalized polyolefin is Lotryl® 20 MA 08, which is a copolymer of ethylene and n-methyl acrylate with a content by weight of acrylate of 20% and having an MFI of 8 g/10 min (190° C./2.16 kg).

The starch used is modified starch (TPS 3947) sold by Roquette.

The compositions of the various mixtures prepared are summarized in Table 1 below.

TABLE 1

| | | % by weight | | |
|---|---|---|---|---|
| | | of copolyether- | | |
| | | block-amide | % by weight of | % by |
| | | PEBAX ® | functionalized | weight of |
| | | MV 3000 | polyolefin | starch |
| Comparative | A | 100 | 0 | |
| examples | B | 70 | 30 | |
| | C | 50 | 50 | |
| | D | 30 | 70 | |
| Examples | E | 50 | 0 | 50 |
| according to | F | 20 | 40 | 40 |
| the invention | | | | |

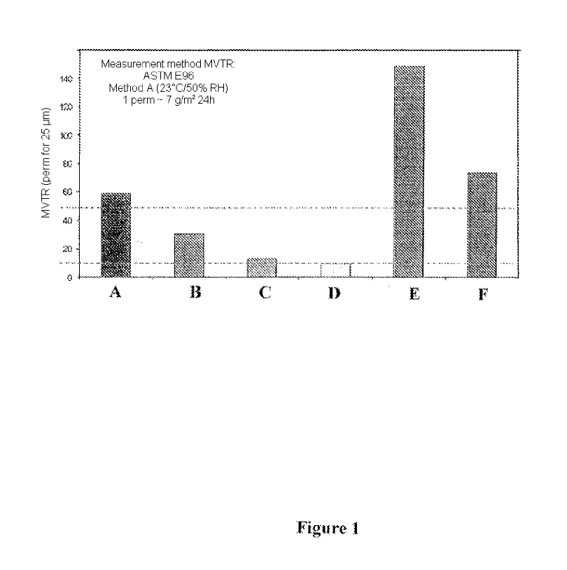

The values for the permeability measured on these various films are represented in FIG. 1. The results obtained with Examples A to D show that the permeability of a film comprising a mixture of a copolyether-block-amide and a functionalized polyolefin decreases when the percentage of copolyether-block-amide decreases.

On comparing Example E with Example A, it is found that replacing 50% of the copolyether-block-amide with starch makes it possible to at least double the permeability of the film. Furthermore, on comparing Example F with Example A, it is found that a film comprising 40% of starch and 60% of a mixture of a copolyether-block-amide and a functionalized polyolefin exhibits a better permeability than a film comprising solely a copolyether-block-amide.

The films of Examples E and F according to the invention exhibit a permeability of approximately 1050 g/m² and 525 g/m², which is markedly greater than the value of 350 g/m² desired. The films according to the invention can thus be used as waterproof-breathable roof-decking films or wall insulating films. No decomposition of the films of Examples E and F was observed despite exposure to moisture.

1. Waterproof-breathable film comprising:
a) a copolyether-block-amide and/or a copolyether-block-ester and/or a functionalized polyolefin;
b) starch.

2. Waterproof-breathable film according to claim 1, in which the percentage of starch represents from 10 to 90% of the weight of the composition, preferably from 30 to 80% and more preferably from 40 to 70% of the weight of the composition.

3. Waterproof-breathable film according to either of the preceding claims, in which the copolyether-block-amide comprises from 1 to 80% by weight of polyether blocks and from 20 to 99% by weight of polyamide blocks, preferably from 4 to 80% by weight of polyether blocks and from 20 to 96% by weight of polyamide blocks and more preferably from 30 to 60% by weight of polyether blocks and from 40 to 70% by weight of polyamide blocks.

4. Waterproof-breathable film according to claim 3, in which the polyamide block is chosen from the group consisting of the 6, 11, 12, 6.6, 6.10 or 6.12 blocks.

5. Waterproof-breathable film according to claim 3 or 4, in which the polyether block derives from polyethylene glycol (PEG).

6. Waterproof-breathable film according to one of the preceding claims, in which the functionalized polyolefin comprises a grafting by a monomer chosen from the group consisting of unsaturated carboxylic acids, unsaturated carboxylic acid anhydrides, vinyl monomers, acrylic monomers and a mixture of these.

7. Waterproof-breathable film according to claim 6, in which the functionalized polyolefin is chosen from the group consisting of ethylene/acrylic ester copolymers, ethylene/acrylic ester/maleic anhydride copolymers and ethylene/acrylic ester/glycidyl methacrylate copolymers.

8. Waterproof-breathable film according to one of the preceding claims, in which the film has a thickness of between 25 and 500 μm, preferably between 50 and 400 μm.

9. Process for the manufacture of the film according to one of the preceding claims, comprising the stages of:
a) making available a polymer chosen from a copolyether-block-amide, a copolyether-block-ester and a functionalized polyolefin;
b) making available starch;
c) mixing and heating the polymer or polymers of stage a) and the starch at a temperature greater than the melting point of the polymer or polymers of stage a) and than the melting point of the starch;
d) drawing the mixture in order to form a film.

10. Process according to claim 9, in which the stage of drawing the mixture is carried out by blow extrusion.

11. Process according to claim 9, in which the stage of drawing the mixture is carried out by cast extrusion.

12. Process according to one of claims 9 to 11, in which the heating of stage c) is carried out at a temperature lower than 200° C., preferably lower than 190° C. and more preferably lower than 180° C.

13. Use of a waterproof-breathable film according to one of claims 1 to 8 to insulate the walls of a building or for the installation of a roof-decking film.
